(19) United States
(12) Patent Application Publication
(10) Pub. No.: US 2018/0291839 A1
(43) Pub. Date: Oct. 11, 2018

(54) EXHAUST COOLING ARRANGEMENT

(71) Applicant: Sikorsky Aircraft Corporation, Stratford, CT (US)

(72) Inventors: Joseph Pantalone, III, Guilford, CT (US); Jeremy Remi Beaudry, Monroe, CT (US)

(21) Appl. No.: 15/765,352

(22) PCT Filed: Aug. 15, 2016
(86) PCT No.: PCT/US2016/047007

§ 371 Date: Apr. 2, 2018

Related U.S. Application Data
(60) Provisional application No. 62/240,726, filed on Oct. 13, 2015.

(51) Int. Cl. F02K 1/82; F02K 3/06

(52) U.S. Cl. CPC F02K 1/822; F05D 2220/329; F02K 3/06

(57) ABSTRACT

An exhaust cooling arrangement includes a first duct having a first inlet and a first outlet, a fairing positioned radially outwardly of the first duct defining an annular space between the fairing and the first duct, and a second duct having a second inlet and a second outlet, the second inlet being positioned upstream of the first outlet within the annular space such that fluid within the annular space can flow along an inside surface of a wall defining the second duct and an outside surface of the wall, upstream being defined by a direction of fluid flow through the annular space.

### BACKGROUND

Exhaust ducts on vehicles can create infrared signatures that may be detectable by imaging equipment configured to image objects in the infrared wavelengths. Such signatures can be used to target the vehicles. Devices and methods to alter the infrared signatures of a vehicle are of interest to those concerned with such matters.

### BRIEF DESCRIPTION

Disclosed herein is an exhaust cooling arrangement. The arrangement includes a first duct having a first inlet and a first outlet, a fairing positioned radially outwardly of the first duct defining an annular space between the fairing and the first duct, and a second duct having a second inlet and a second outlet, the second inlet being positioned upstream of the first outlet within the annular space such that fluid within the annular space can flow along an inside surface of a wall defining the second duct and an outside surface of the wall, upstream being defined by a direction of fluid flow through the annular space.

In addition to one or more of the features described above, or as an alternative, further embodiments include the fairing defining a fairing outlet and the second outlet is positioned upstream of the fairing outlet.

In addition to one or more of the features described above, or as an alternative, further embodiments include the first duct and the second duct being positioned upstream of an outlet of the fairing.

In addition to one or more of the features described above, or as an alternative, further embodiments include the first outlet being positioned downstream of the second inlet.

In addition to one or more of the features described above, or as an alternative, further embodiments include the first outlet being positioned proximate the second inlet.

In addition to one or more of the features described above, or as an alternative, further embodiments include at least one additional duct having at least one additional inlet, the at least one additional duct is at least partially positioned in a second annular space defined between the second duct and the fairing.

In addition to one or more of the features described above, or as an alternative, further embodiments include the at least one additional inlet being positioned upstream of the second outlet.

Further disclosed herein is an aircraft. The aircraft includes a fuselage, an engine in operable communication with the fuselage, and any of the foregoing cooling exhaust arrangements.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 depicts a sectional schematic view of a gas turbine engine employing an exhaust cooling arrangement disclosed herein;

FIG. 2 depicts a partial view of FIG. 1 at greater magnification;

FIG. 3 depicts a sectional schematic view of an alternate exhaust cooling arrangement disclosed herein; and

FIG. 4 depicts an aircraft employing the exhaust cooling arrangement of FIG. 1.

### DETAILED DESCRIPTION

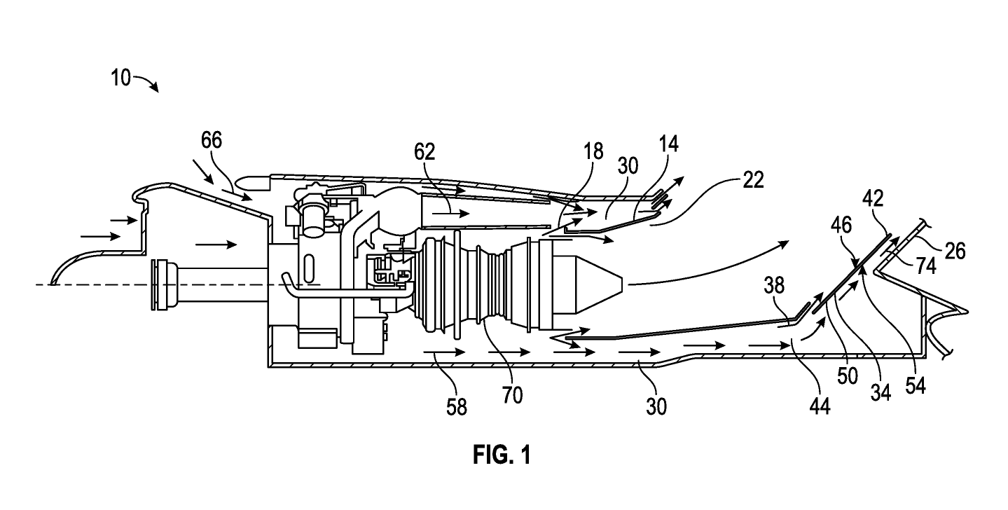

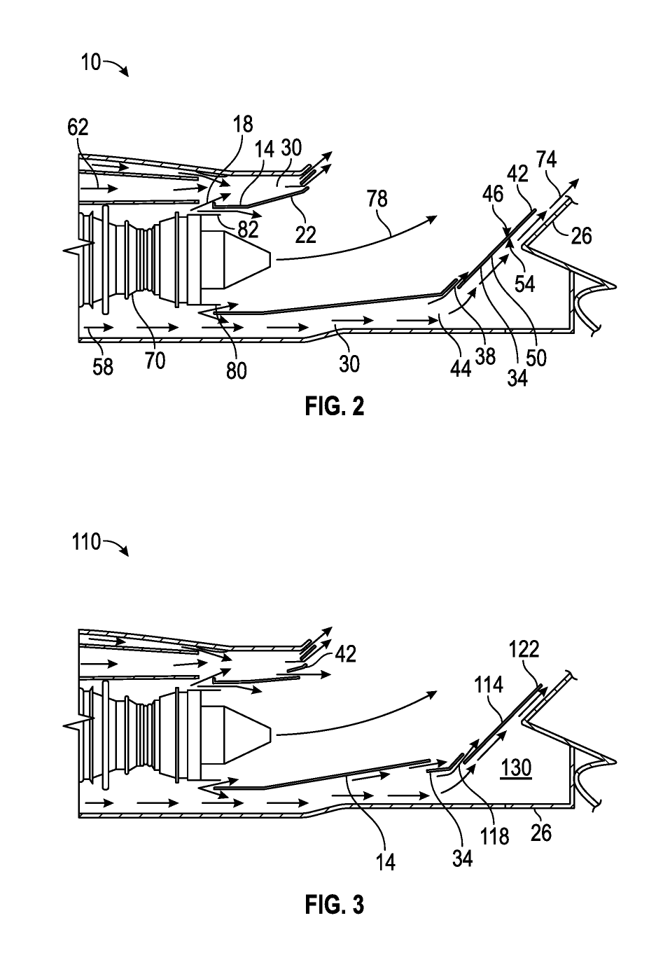

Referring to FIGS. 1 and 2, an embodiment of an exhaust cooling arrangement disclosed herein is illustrated generally at 10. The exhaust cooling arrangement 10 includes a first duct 14 with a first inlet 18 and a first outlet 22, a fairing 26 positioned radially outwardly of the first duct 14 defining an annular space 30 between the fairing 26 and the first duct 14. The arrangement 10 also includes a second duct 34 having a second inlet 38 and a second outlet 42. The second inlet 38 is positioned upstream of the first outlet 22 within the annular space 30 such that fluid 44 within the annular space 30 can flow along a radially inside surface 46 of a wall 50 defining the second duct 34 and a radially outside surface 54 of the wall 50. The upstream direction as referred to herein being defined by a direction of flow of the fluid 44 through the annular space 30.

The fluid 44 within the annular space may be from a combination of sources and can include, ram air 58, inlet particle separator (IPS) air 62, and cooling air 66, for example. The ram air 58 and the cooling air 66 can be used to convectively cool an engine 70, illustrated in one embodiment as a gas turbine engine although other engines are contemplated, as the fluid 44 flows therepast. The fairing 26 provides an aerodynamic enclosure to the engine 70, and the ducts 14 and 34 while also obscuring a line-of-sight to those components by infrared imaging equipment. Positioning the ducts upstream of an outlet 74 of the fairing 26 can further reduce angles that permit direct imaging of the ducts 14 and 34 via line-of-sight. In one embodiment the first outlet 22 of the first duct 14 and the second outlet 42 of the second duct 34 are both upstream of an outlet 74 of the fairing 26.

The exhaust arrangement 10 is configured such that exhaust 78 from the engine 70 exiting a flue 80 is prevented from flowing radially outwardly of both the first duct 14 and the second duct 34. This keeps the higher temperature exhaust 70 radially inwardly of both of the ducts 14 and 34. To accomplished this an outlet 82 of the flue 80 is positioned downstream of the first inlet 18 and the first outlet 22 is positioned downstream of the second inlet 38 though the first outlet 22 is proximate the second inlet 38.

Referring to FIG. 3, an alternate embodiment of an exhaust cooling arrangement disclosed herein is illustrated generally at 110. The arrangement 110 has many similarities to the arrangement 10 and therefore like elements will be identified with the same reference characters and primarily only differences in the embodiments will be described in detail hereunder. The arrangement 110 includes at least one additional duct 114, with just one being illustrated although any practical number could be employed. The additional duct 114 has an inlet 118 and an outlet 122. The additional duct 114 is at least partially positioned within an annular space 130 defined between the second duct 34 and the fairing 26. The inlet 118 is positioned upstream of the second outlet 42.

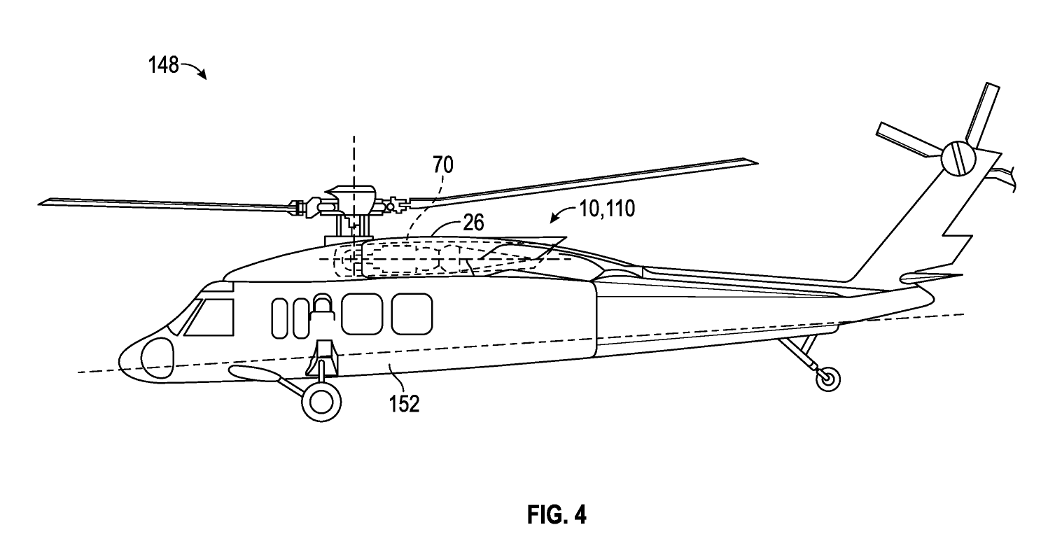

Referring to FIG. 4, a vehicle 148 is illustrated as a rotary wing aircraft 148 having among other things a fuselage 152, the gas turbine engine 70, the fairing 26 and one of the exhaust cooling arrangements 10, 110 disclosed herein. The arrangements 10, 110 can be disposed on the aircraft 148 to alter an infrared signature of the aircraft 148 in manners disclosed herein. It should be pointed out that the arrangements 10, 110 are not limited to use with the vehicle 148 and can be employed on any exhaust system including but not limited to ground based vehicles, seafaring vessels as well as stationary engines that emit exhaust (not shown) while remaining within the scope of the claims presented herein.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An exhaust cooling arrangement, comprising:
a first duct having a first inlet and a first outlet;
a fairing positioned radially outwardly of the first duct defining an annular space between the fairing and the first duct; and
a second duct having a second inlet and a second outlet, the second inlet being positioned upstream of the first outlet within the annular space such that fluid within the annular space can flow along an inside surface of a wall defining the second duct and an outside surface of the wall, upstream being defined by a direction of fluid flow through the annular space.

2. The exhaust cooling arrangement of claim 1, wherein the fairing defines a fairing outlet and the second outlet is positioned upstream of the fairing outlet.

3. The exhaust cooling arrangement of claim 1, wherein the first duct and the second duct are positioned upstream of an outlet of the fairing.

4. The exhaust cooling arrangement of claim 1, wherein the first outlet is positioned downstream of the second inlet.

5. The exhaust cooling arrangement of claim 1, wherein the first outlet is positioned proximate the second inlet.

6. The exhaust cooling arrangement of claim 1, further comprising at least one additional duct having at least one additional inlet, the at least one additional duct is at least partially positioned in a second annular space defined between the second duct and the fairing.

7. The exhaust cooling arrangement of claim 6, wherein the at least one additional inlet is positioned upstream of the second outlet.

8. An aircraft, comprising:
a fuselage;
an engine in operable communication with the fuselage; and
a cooling exhaust arrangement of claim 1 being in operable communication with the engine.
